(19) United States
(12) Patent Application Publication
(10) Pub. No.: US 2023/0088246 A1
(43) Pub. Date: Mar. 23, 2023

(54) SYSTEM AND METHOD FOR RESTORING NATURAL GAS SERVICE TO A NATURAL GAS DISTRIBUTION SYSTEM

(71) Applicant: Consolidated Edison Company of New York, Inc., New York, NY (US)

(72) Inventor: Nick C. Thompson, Montgomery, NY (US)

(21) Appl. No.: 17/448,107

(22) Filed: Sep. 20, 2021

(51) Int. Cl. G06Q 10/00; G06Q 50/06; G06Q 10/06; G06F 16/23; G06K 7/14

(52) U.S. Cl. CPC G06Q 10/20; G06Q 50/06; G06Q 10/063114; G06F 16/2358; G06K 7/1417

(57) ABSTRACT

A method, system and computer program product are provided for restoring gas service to a portion of a natural gas distribution network is provided. The method includes determining a gas outage has occurred. A geographic area is defined where gas service was lost. Customer data associated with the customer locations is identified in the geographic area on the natural gas distribution network and storing the customer data in a database. An incident commander assigns customer locations to field resources. The field resources are notified of the customer locations assigned to the field resources. The field resources disconnect the customer locations from the natural gas distribution network. The field resources update the database with the customer data to indicate the customer location has been disconnected by the field resources. On a computing device the customer data is displayed to the incident commander indicating that the customer location has been disconnected.

### BACKGROUND

The subject matter disclosed herein relates to gas distribution systems, and in particular to a system and method for responding to a gas leak event.

Natural gas delivery or distribution systems, such as those that deliver gas to a residential unit, utilize pipes that are connected to the house via a valve, such as a wing cock valve, and a meter, or via a curb valve. Typically, the pipe is mostly disposed underground and rise to the surface adjacent the where the pipe is to enter the building. The wing cock valve is used to disconnect service to the building when repairs are to be performed. In many instances, the valve may be located in an inconvenient location, such as behind shrubbery for example. In other instances, the wing cock valve is inaccessible and the service is disconnected using the underground curb valve.

In the event that the flow of gas in the natural gas distribution system is interrupted, a process is followed to disconnect customer locations from the distribution system until repairs are made. Typically this involves identifying the houses or buildings in the impacted areas, printing out paper lists with information on the houses or buildings and sending out field resources/personnel to turn off the gas service to the impacted houses or buildings. Since the system relies on paper lists, the coordinating of the effort and tracking of the status is time consuming and inefficient. Further, once repairs are made, the same field resources need to be located and sent back to the area to reestablish the flow of gas to the impacted houses and buildings. Further, once the operation of the distribution system is restored, the paper notes from the field personnel need to be collected, compiled and saved for archiving and auditing.

While existing methods of responding to disruptions in natural gas distribution systems are suitable for their intended purposes, a need for improvement remains in providing a system and method that facilitates communication between utility personnel.

### BRIEF DESCRIPTION

According to one aspect of the disclosure a method of restoring gas service to a portion of a natural gas distribution network is provided. The method includes determining a gas outage has occurred. A geographic area is defined where gas service was lost. Customer data associated with the customer locations is identified in the geographic area on the natural gas distribution network and storing the customer data in a database. An incident commander assigns customer locations to field resources. The field resources are notified of the customer locations assigned to the field resources. The field resources disconnect the customer locations from the natural gas distribution network. The field resources update the database with the customer data to indicate the customer location has been disconnected by the field resources. On a computing device the customer data is displayed to the incident commander indicating that the customer location has been disconnected.

According to another aspect of the disclosure, a system for restoring natural gas service to a portion of a natural gas distribution network is provided. The system including a server at a first location, the server having a first processor responsive to executable computer instructions when executed on the first processor for receiving an input and transmitting a data package in response to receiving the input, the input including customer data associated with the portion of the natural gas distribution network, the customer data including a plurality of fields, at least one of the plurality of fields being selected from a group comprising: meter status, facility type, pilot light status, and accessibility. A database is associated with the server. A plurality of mobile computing devices are located at a second location, the second location being different than the first location, the plurality of mobile computing devices being coupled to communicate with the server and the database, each of the first plurality of mobile devices having a first display and a second processor, the second processor being coupled to the first display, the second processor being responsive to executable computer instructions for displaying the customer data, the second processor further being responsive to executable computer instructions for receiving one or more inputs, by a field resource, changing the customer data and transmitting the changed customer data to the database.

According to another aspect of the disclosure a computer-implemented method for facilitating a restoring of gas service to a portion of a natural gas distribution network is provided. The method including determining a gas outage has occurred. A geographic area where gas service was lost is defined at a server. Customer data associated with the customer locations are identified on the service for the geographic area on the natural gas distribution network and storing the customer data in a database, the database being associated with the server. An incident commander computing device assigns customer locations to field resources. A field resource computing device is notified, via a computer network, a of the customer locations assigned the field resources. The customer locations are disconnected, by the field resources, from the natural gas distribution network. In response to an input on the field resource computing device, the customer data is updated to indicate the customer location has been disconnected by the field resources. The updated customer data is transmitted to the database. The customer data indicating that the customer location has been disconnected is displayed on the incident commander computing device.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is schematic view of a underground gas system in accordance with an embodiment;

FIG. 2 is a flow diagram of a method for responding to a gas distribution event;

FIGS. 3A-3E are illustrations of administration screens for tracking and managing the gas distribution event in accordance with an embodiment;

FIGS. 4A-4G are illustrations of a mobile device that may be used by field personnel during the gas distribution event in accordance with an embodiment;

FIGS. 5A-5E are illustrations of dashboard screens for tracking the gas distribution event in accordance with an embodiment;

FIG. 6 depicts a schematic illustration of a cloud computing environment according to one or more embodiments described herein;

FIG. 7 depicts a schematic illustration of an abstraction model layers according to one or more embodiments described herein; and

FIG. 8 depicts a schematic illustration of a computer system according to one or more embodiments described herein.

The detailed description explains embodiments of the invention, together with advantages and features, by way of example with reference to the drawings.

### DETAILED DESCRIPTION

Embodiments of the present disclosure provide advantages in administering and executing a response to a natural gas outage event. Embodiments of the present disclosure allow for remote management and automatic notification of remote resources for the securing, repairing, and reestablishing the natural gas service.

Descriptions of embodiments herein describe utility personnel by certain job titles or names, these are for exemplary purposes and are not intended to be limiting. Other titles may be used without deviating from the teachings of the present disclosure.

As used herein, the term “incident commander” refers to a person who works for, or on behalf of, the natural gas distribution utility that acts as the manager who coordinates the efforts to restore service. As used herein, the term “field resource” refers to a person, or a team of people, who works for, or on behalf of, the natural gas distribution utility that are trained to disconnect service at customer locations, turn off pilot lights, and re-ignite pilot lights. As used herein, the term “field crew” refers to a person, or team of people, who work for or on behalf of the natural gas distribution utility to repair or correct the issue or issues that resulted in the natural gas outage event. As used herein, the terms “natural gas distribution utility” or “gas distribution utility” refers to an entity or corporation, that is typically regulated by a local or state governmental agency, to deliver natural gas and provide associated services and infrastructure to the public.

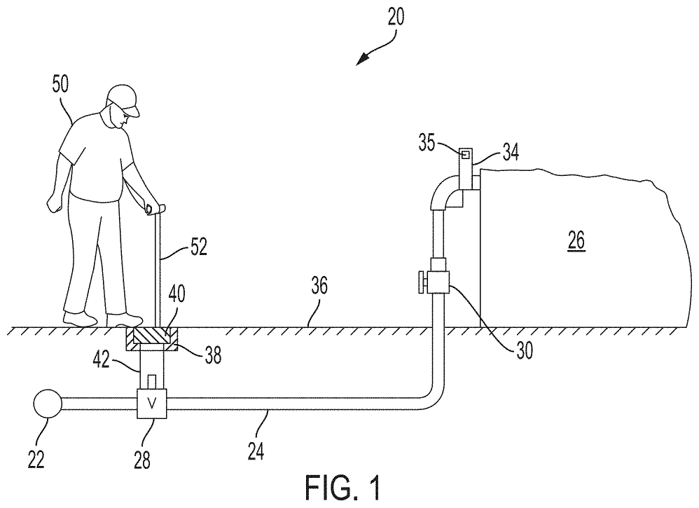

Referring to FIG. 1, an embodiment is shown of a gas delivery system 20. The gas system 20 includes a main gas pipe 22 which includes one or more branch conduits 24 that connect the main gas pipe 22 to a consumer 26, such as a residential house for example or another gas pipe same as pipe 22. The system 20 may include a number of valves 28, 30 that control the flow of gas, such as natural gas for example, to the consumer 26. The amount of gas used by the consumer 26 is measured by a meter 34. In an embodiment, the meter 34 includes a machine readable symbol 35, such as a bar-code or a QR code for example.

Some of the valves, such as valve 28 may be disposed below ground level 36. It should be appreciated that while the illustrated embodiment shows the underground valve 28 as being to the branch pipe 24 (sometimes referred to as a curb valve), this is for exemplary purposes and the claims should not be so limited and underground valves may be located on the main gas pipe 22. In some instances, to access these subterranean valves, an access structure is provided, such as the valve box 38 for example. The valve box 38 has a removable cover 40. The valve box 38 has an opening in the bottom that provides access to a riser shaft 42. The riser shaft 42 is generally a hollow cylindrical body (e.g. a pipe) that creates an airspace beneath the valve box 38. Generally, the underground valve, such as valve 28, is located directly below and at least partially within the riser shaft 42. It should be appreciated that in some embodiments, the valve 28 may be buried with no direct access from the surface.

It should be appreciated that in some embodiments the valve for natural gas service may be located within the consumers structure. In the event of a gas distribution outage event, utility personnel may have to enter the consumers structure or facility to shut the valve. It should also be appreciated that the consumers structure or facility may include one or more pilot lights that serves as an ignition source for an appliance, such as a furnace, water heater, or fireplace for example.

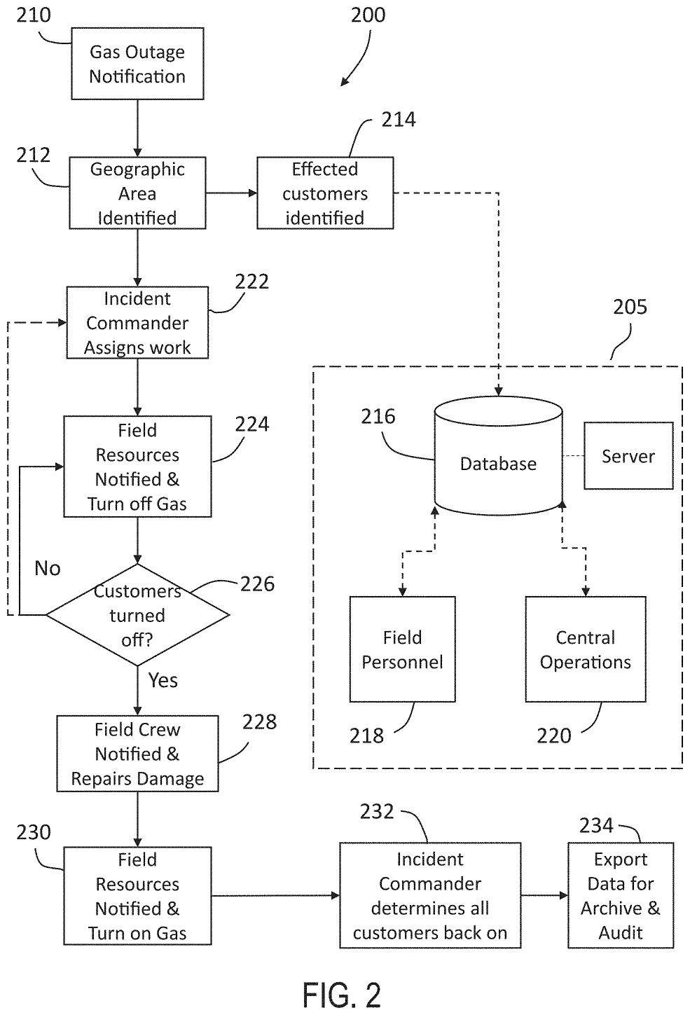

In the distribution of natural gas from time to time events may occur that result in an outage within a portion of the gas distribution network. A gas distribution outage may be caused by a variety of factors, such as but not limited to a third party performing an excavation that disrupts a gas main pipe to an area with no back feed provisions. It should be appreciated that in this situation, customers downstream from the gas main breakage would lose the natural gas service. Referring now to FIG. 2 and FIGS. 3A-5E a method 200 and system 205 are shown for managing the gas network outage. The method 200 starts in block 210 where a gas outage notification is received, such as at a centralized control center for example. The method 200 then proceeds to block 212 where the impacted geographic area impacted by the outage is identified. Typically, the centralized control center will have electronic or digital maps that indicate the location of the natural gas infrastructure including the connections to customer locations. In an embodiment, the operator identifies the impacted area by drawing on the computer an outline around a perimeter about the area on a map displayed on a computer terminal in the centralized control center.

With the area identified, the system 205 can automatically identify the consumer locations within the area in block 214. In an embodiment, the digital mapping system of the natural gas infrastructure uses the drawing outline of the perimeter of the impacted area to extract the customer data for the customer locations within the impacted area. In an embodiment, the customer data is extracted into a spreadsheet or other file format (e.g. a tab-delineated file). The consumer location information for the event is stored within a database 216 that is accessible by computing devices connected the centralized control center 218 or on the utility computer network, along with mobile devices 220 carried by field personnel. In an embodiment, the database 216 is a Sharepoint™ site produced by Microsoft Corporation of Redmond, Wash. USA. In an embodiment, the database 216 is associated with one or more servers 215 that are configured to communicate with the computer network to transmit data between the database 216 and computing devices associated with the field personnel 218 and central operation personnel 220.

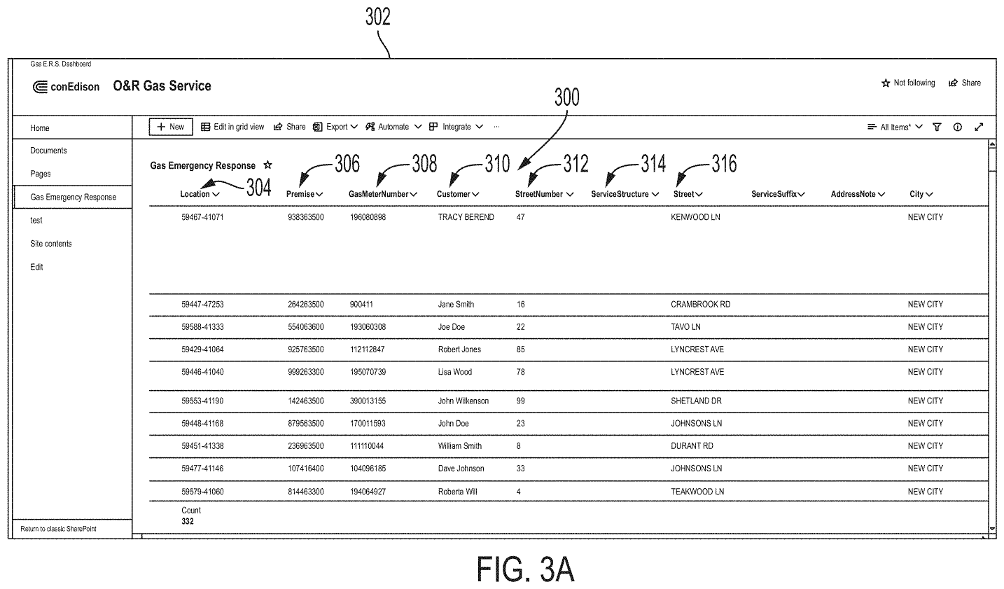

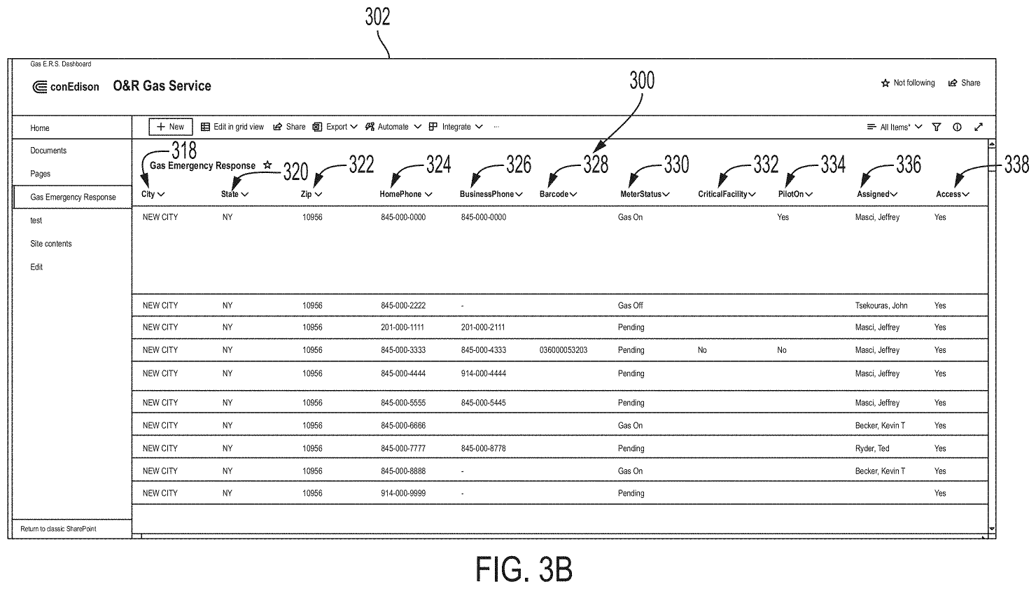

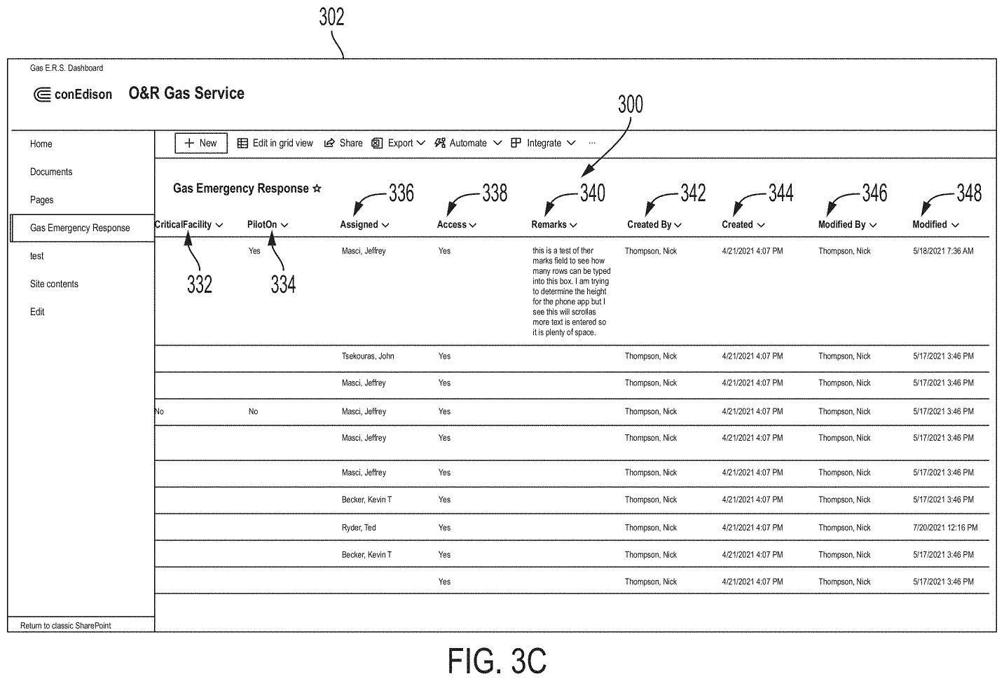

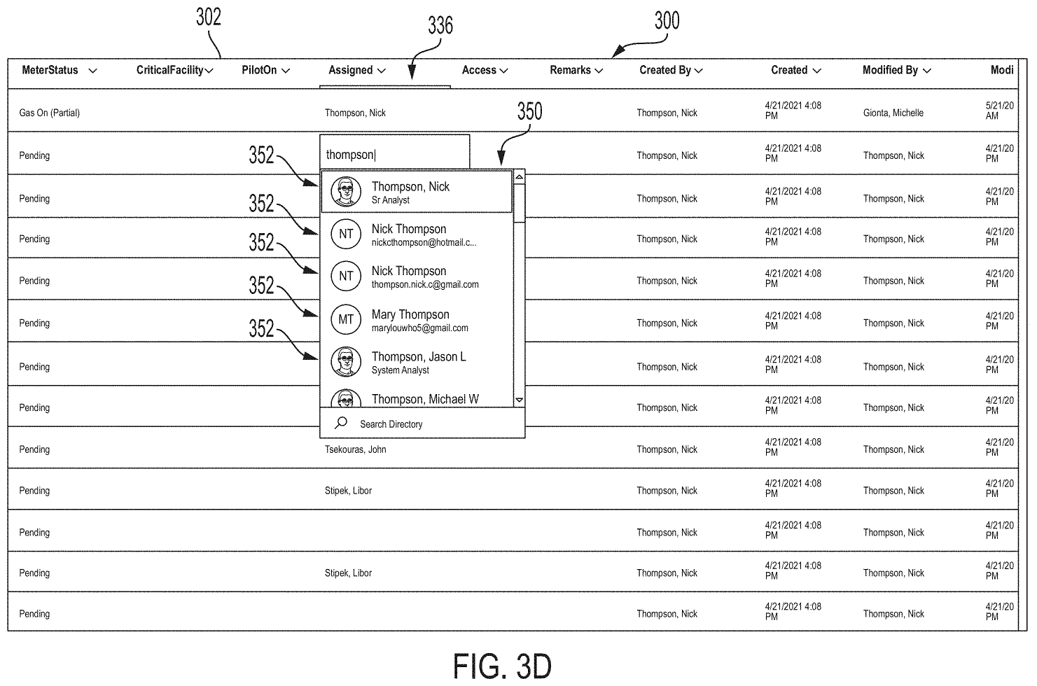

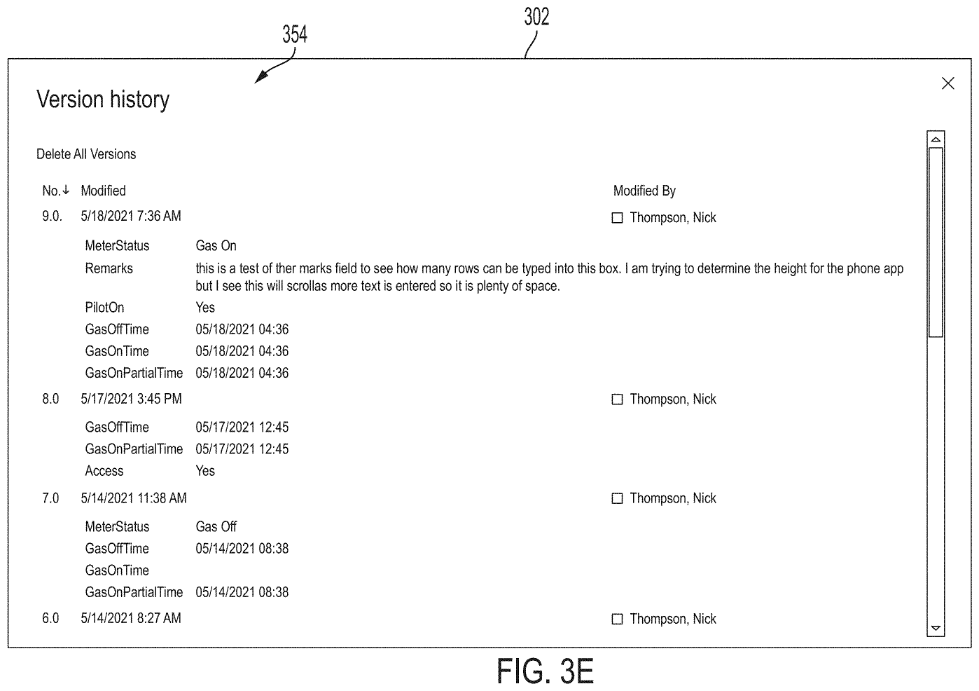

The storing of the consumer location data on the database 216 allows the system 205 to generate a report 300 for the gas outage response. The report 300 is accessible via computer software, such as web browser 302 for example, to the incident commander whether the incident commander is in the centralized control center or remotely located. It should be appreciated that this provides advantages in decreasing the response time of the gas utility over the prior art system of printing a paper report and driving it to the impact area. The data in the report 300 may include but is not limited to: a location identifier 304, a premise identifier 306, a gas meter identifier 308, a customer name 310, a street number 312, a service structure 314, a street name 316, a city 318, a State 320, a ZIP code 322, a home phone number 324, a business phone number 326, a meter bar code identifier 328, a meter status 330, a critical facility identifier 332, a pilot indicator 334, a personnel assignment field 336, an access indicator 338, a remarks field 340, a created by field 342, a created date 344, a modified by field 346, and a modified data 348. It should be appreciated that in the embodiment shown in FIGS. 3A-3C, the report 300 is larger than is displayable on a computer display and the operator may have to scroll or shift the computer software window to view additional columns of data.

It should be appreciated that the information in the report 300 may be updated in real time by either the incident commander (either in the centralized control center or remotely located), or as discussed in more detail below by field resources or field crews working in the area impacted by the gas outage event.

The method 200 proceeds to block 222 where the incident command assigns the work to field resources. In the event of loss of service in the natural gas supply, it is industry standard procedure to disconnect or turn-off service to all of the effected customers. That way, when service is restored, the customers may be reconnected in a controlled manner and no pilot lights will remain unlit, allowing gas into the customers structure. In an embodiment, shown in FIG. 3D, the data displayed in the assignment column is a drop down list 350, such that when the incident commander selects or clicks on the field, a list of available field resources 352 (e.g. utility personnel tasked with turning off and turning on the valve 28,30). In an embodiment, once the field resource 352 is selected, the system 205 automatically notifies the field resource 352 via their mobile device as discussed in more detail herein. In an embodiment, the drop down list 350 may optionally indicate for each listed personnel 352 a status for the resource, such as available, unavailable, off work, or workload status (e.g. how many consumer locations were assigned). In still other embodiments, the drop down list 350 may indicate for each listed personnel a distance that the resources is currently located relative to the impacted area.

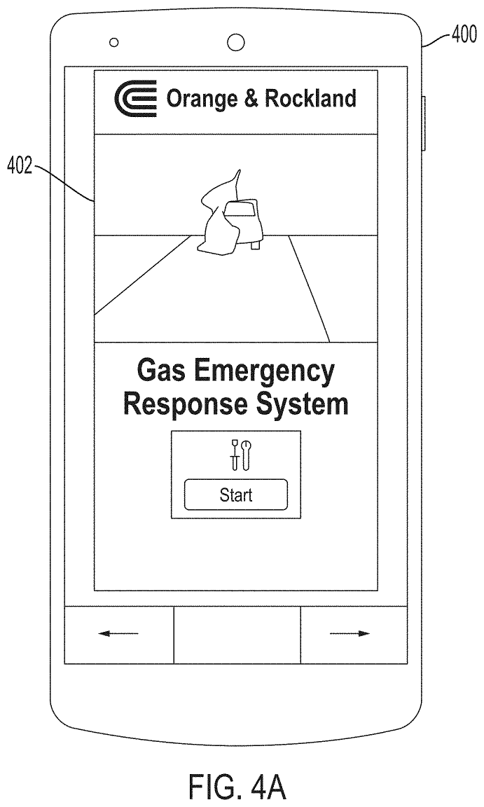

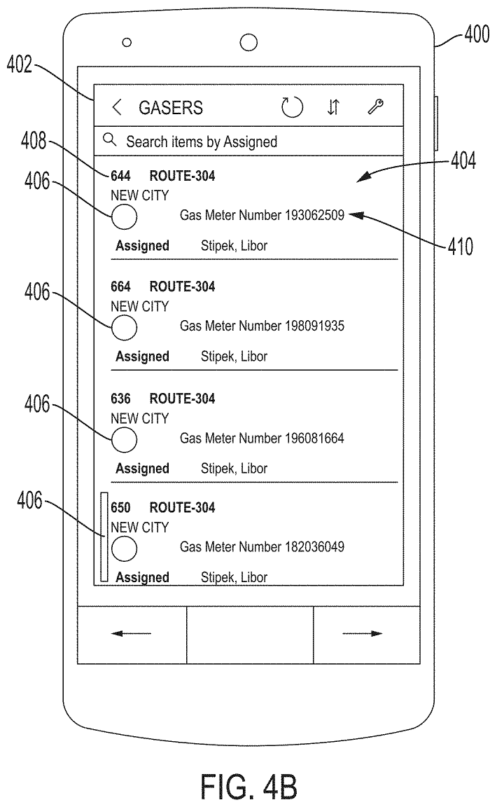

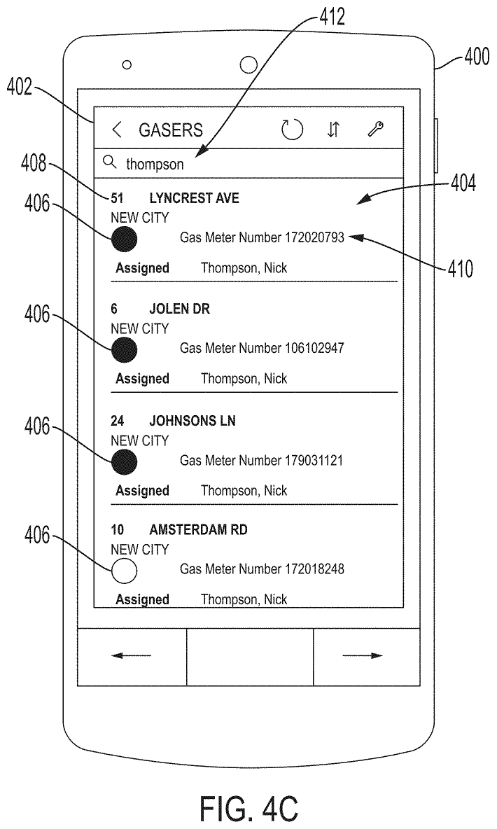

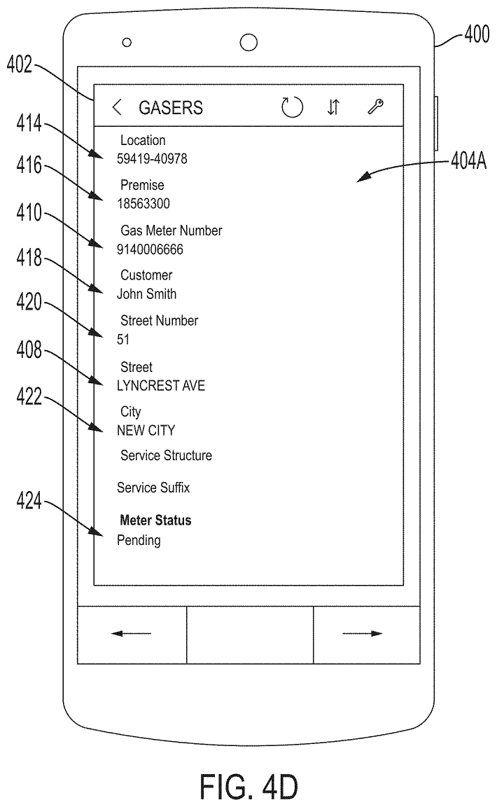

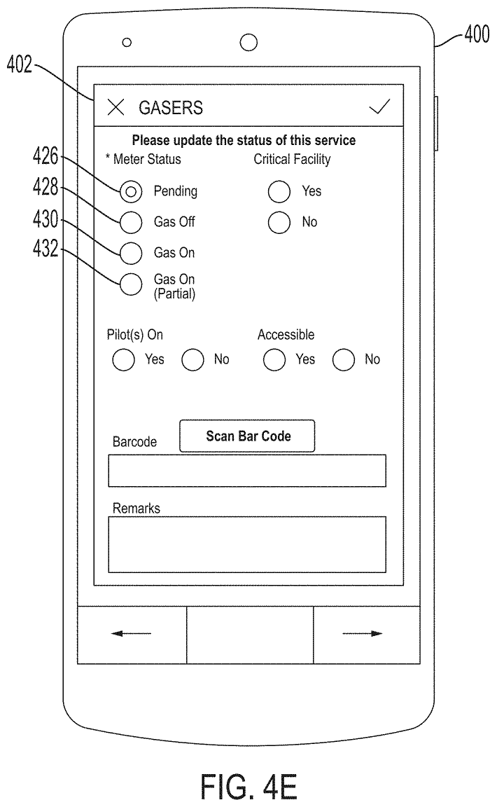

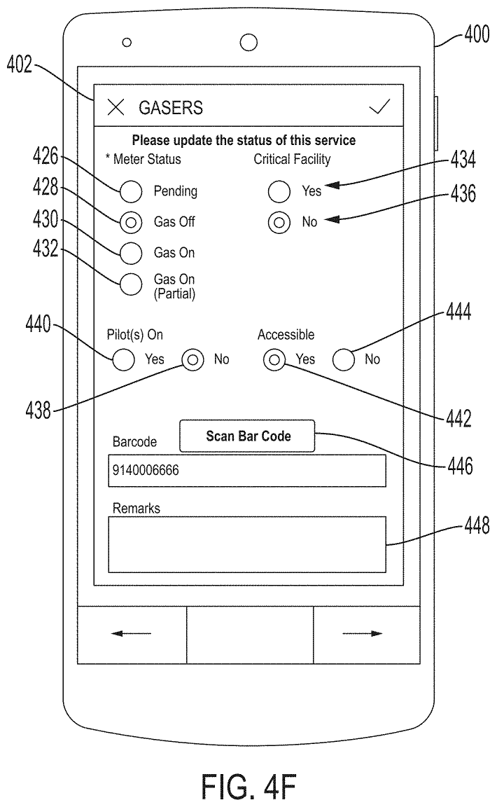

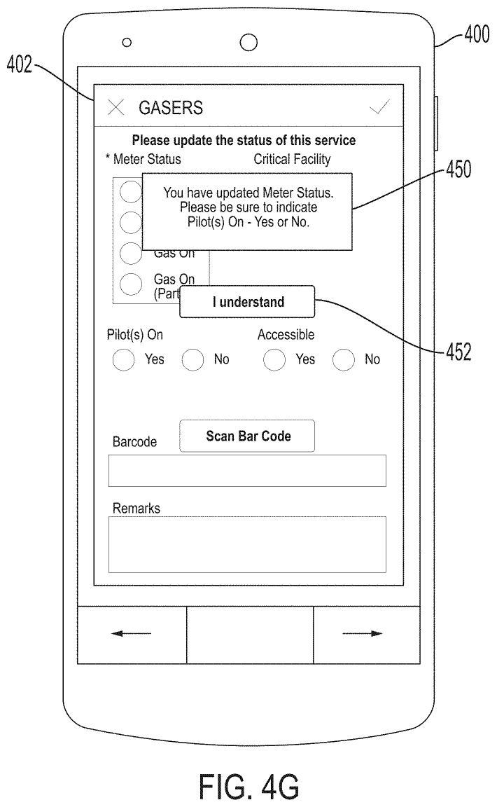

With reference now to FIG. 2 and FIGS. 4A-4F, the method 200 then proceeds to block 224 where the field resources are notified, such as via their mobile device 400. The mobile device 400 includes one or more processors and a display. The mobile device 400 further includes communications circuits configured to communicate via a computer network with the database 216. In this embodiment, the mobile device 400 includes a software application 402 that is configured to communicate with the database 216. In an embodiment, the application 402 includes an identifier (e.g. the users cell phone number) that is stored in the database 216 and associates a particular mobile device 400 with one of the field resources 352 listed in the drop down list 350. In an embodiment, the application 402 is configured to periodically contact the database 216 to determine if the field resource has been assigned a task. In other embodiments, the system 205 is configured to push or transmit data to the mobile device 400.

In some embodiments, when the mobile device 400 and the application 402 have received a signal or a communication that work has been assigned, the application 402 is configured to display a notification, the notifications may include but are not limited to a banner, a lock screen window, a notification center window, an icon badge, a popup window, or an audible sound for example. Using the application 402, the field resource can view what work has been assigned. As shown in FIG. 4B, the field resource can pull up a list of customer records 404 where gas service needs to be disconnected. In an embodiment, the customer record includes an address 408 and a gas meter information 410. In an embodiment, each customer record 404 includes a graphical indicator 406. The graphical indicator 406 provides a a visual indication to the field resource as to the status of that customers gas service. In an embodiment, the graphical indicator may be colored to allow the field resource to quickly ascertain the status of assignment. For example, a red circle may indicate that service is in the process of being disconnected, a black circle indicates the gas service is disconnected, a green circle indicates that gas service is still on or connected, a yellow circle indicates that gas service is partially on or connected.

The field resources may then proceed from customer location to customer location that they have been assigned. In an embodiment, shown in FIG. 4C, the field resource may search the customer records, such as by typing their name in the search box 412. This allows the field resource to filter the customer records to find only those records that have been assigned to them. It should be appreciated that the field resource may also use the search functionality on other fields, such as the address, city or gas meter data. As the work is performed, the field resource selects the customer record 404 and enters a second record screen 404A. The screen 404A includes additional information that may be useful to the field resource. The data may include a location identification 414, a premise identification number 416, the gas meter number 410, the customer name 418, the street number 420, the street address 408, the city 422, and a meter status 424.

The field resource may update the status of the customer gas service using the screen shown on FIG. 4E and 4F. In this embodiment, the field resource is prompted to input the status by selecting one of the radio buttons 426, 428, 430, 432. In an embodiment, the selection of the radio button changes the graphical indicator 406 on the customer record 404 (FIG. 4C). When the field resource being disconnecting a customer's service, the pending radio button 426 is selected. When the operation is completed, the field resource then selects the “gas off” radio button 428 as shown in FIG. 4E. At this point, the field resource indicates several other parameters associated with the customer service. This may include whether the customer service is categorized as a “critical facility” by selecting one of the radio buttons 434, 436. As used herein, the term “critical facility” may be a service location where health, safety or wellbeing of persons may be impacted by the loss of natural gas service. A critical facility may be, but is not limited to a residence having a person on life support equipment, a hospital, an urgent care facility, a police station, a fire house, a nursing home, or a rehabilitation facility for example. The field resource may further indicate that the pilot lights have been turned off or left on by selecting one of radio buttons 438, 440. The field resource may also indicate whether the valve 28, 30 is accessible by selecting one of the radio buttons 442, 444.

In an embodiment, the application 402 allows the field resource to scan the machine readable symbol 35 on the meter 34 (FIG. 1), such as by selecting the button 446. This may be accomplished using a camera device that is built into the mobile device 400 for example. In an embodiment, mobile device 400 may include a light source that is activated when the ambient environment is dark so the camera can acquire the image of the machine readable symbol 35. It should be appreciated that the scanning of the machine readable symbol 35 allows for validation that the entered data is associated with the correct customer location. Finally, the field resource may enter notes in the remarks field 448. It should be appreciated that the application 402 is in communication with the database 216 and the updating of the status of the customer location allows the status update to be known to utility personnel both in the field, such as the incident commander for example, and in the central operations facility.

It should be appreciated that is desirable for the status of the pilot lights at the customer location be known. For example, the valve 28, 30 may be accessible (allowing the gas service to be turned off), but the customer is not home so the pilot lights are not turned off. In an embodiment, when the status is changed by selecting one of the one of the radio buttons 426, 428, 430, 432, a message 450 is displayed as shown in FIG. 4G. In an embodiment, the field resource has to acknowledge the message 450 by selecting button 452.

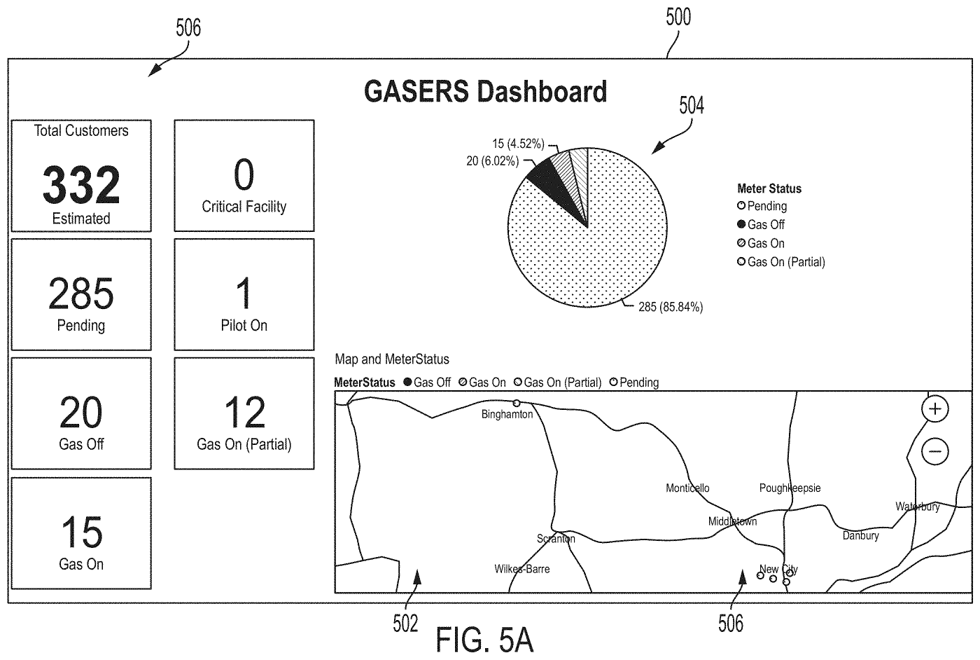

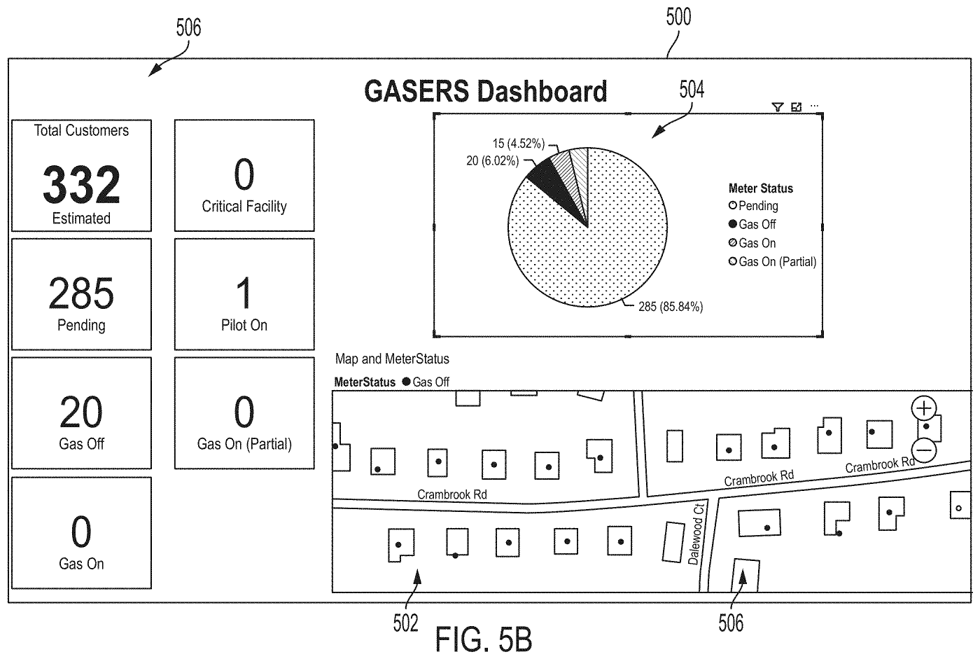

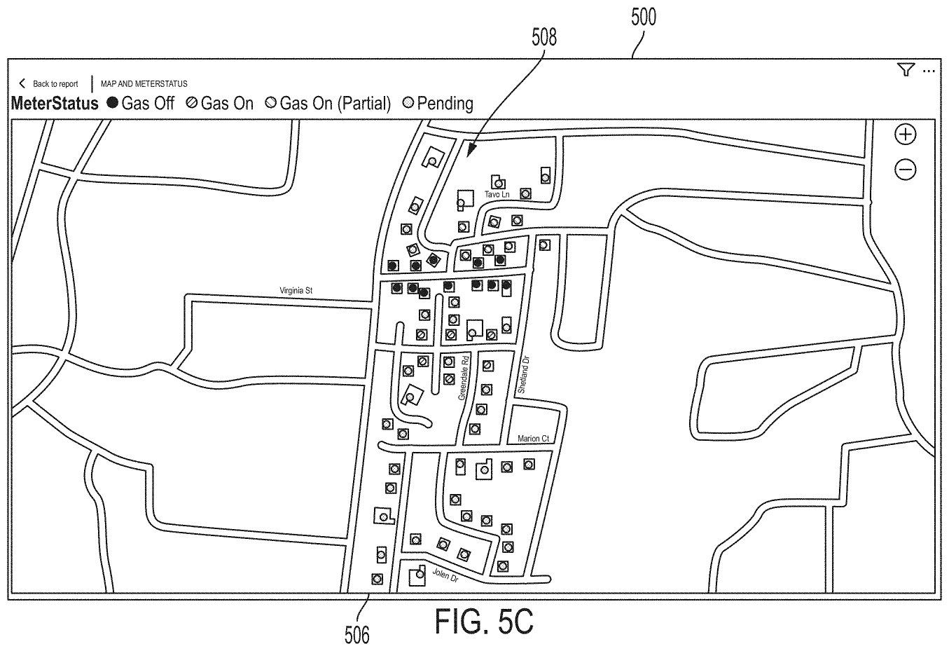

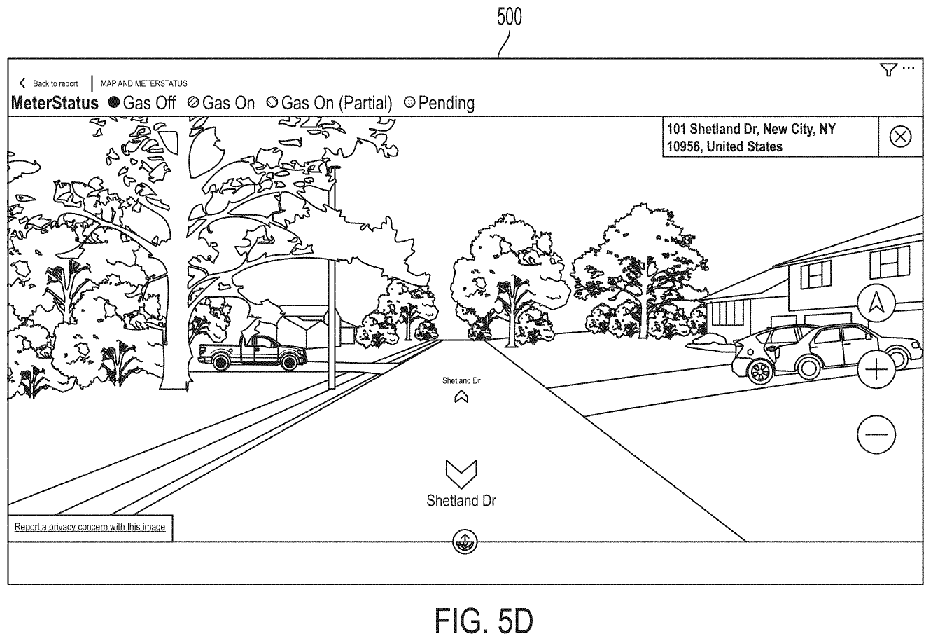

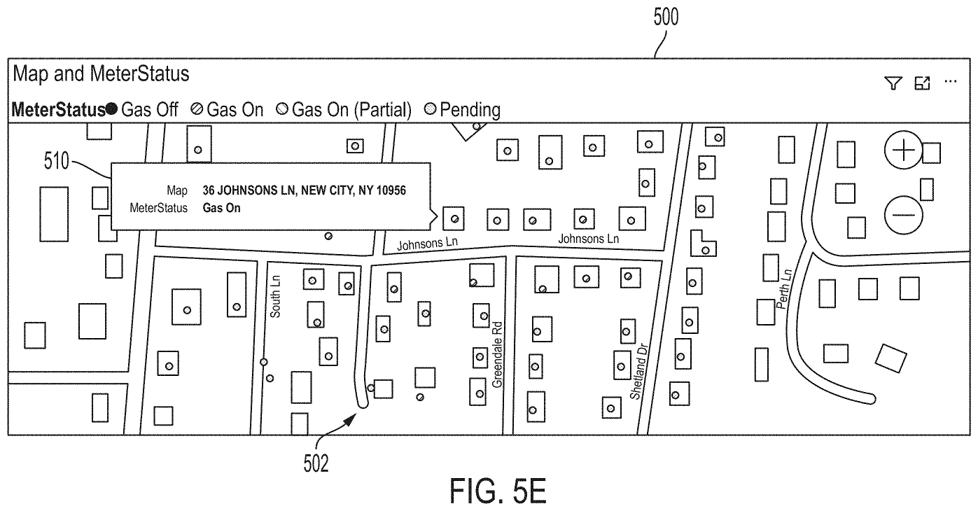

As discussed above, the updating of the status is communicated with the database 216, which allows utility personnel with access to the database to have a real-time or near real-time knowledge of the status of the repair operation. Referring to FIGS. 5A-5E, embodiments are shown of a gas incident dashboard 500 that is available to utility personnel, such as in the central operations for example. In an embodiment, the dashboard 500 is a browser screen that is automatically generated from the database 216, such as by using Power BI produced by Microsoft Corporation for example.

In an embodiment, the dashboard 500 includes three regions, a map region 502, a graphical status region 504 and a numerical status region 506. It should be appreciated that this allows a viewer to either obtain high level or detailed information on the status of the response on a single page. The map region 502 includes graphical indicators 508 (circles) on the location of the customers in the impacted area.

In an embodiment, when a portion of graphical status region 504 is selected (e.g. clicked on with a computer mouse), the map region 502 is changed to display a map of the customer locations having the selected meter status. For example, if the user selects the “Gas Off” portion of the pie chart, the map region changes as is shown in FIG. 5B. Further, by selecting the map region 502, the map may be expanded to show the impacted area 508 with graphical indicators 506 showing the status of each customer location in the impacted area as shown in FIG. 5C. If the user then zoom/magnifies an area, they can switch to a view shown in FIG. 5D that shows an image of the street, sometimes referred to as Street View. Finally, the status and customer information 510 for a customer location may be displayed by hovering a computer cursor over the customer location on the map as shown in FIG.

Referring back to FIG. 2, once the incident commander assigns the work as described herein, the method 200 proceeds to block 224 where the field resources proceed to visit each of the customer locations to disconnect the gas service (e.g. close valve 28, 30) and turn off the pilot lights. The method 200 then proceeds to query block 226 where it is determined whether the gas service at all of the customer locations within the impacted area are disconnected. In an embodiment, when query block 226 returns a negative, the method 200 loops back to block 224 and the field resources continue to disconnect customer locations. In another embodiment, the method 200 loops back to block 222 and prompts the incident commander to review the allocation of assigned work and consider adjusting the allocation of work assignments to reduce the time have service disconnected. In an embodiment, the query block 226 is executed on a periodic or aperiodic basis to automatically prompt the incident commander to reassess the allocation of work assignments.

When the query block 226 returns a positive (e.g. service to all customer locations has been disconnected), the method 200 proceeds to block 228 where the field crews are notified and the damaged equipment or gas main are repaired. In an embodiment, the system 205 is configured to automatically notify the field crew or the incident commander when the last customer service is disconnected (e.g. when all of the indicators 406 are black). Once the damage is repaired, the method 200 proceeds to block 230 where the field resources are notified to start reconnecting the customer locations back to the gas distribution network. In an embodiment, the system 205 automatically notifies the incident commander when the repairs are completed. The incident commander then proceeds to allocate work assignments to the field resources. This may occur for example if the repair takes place over an extended period of time and one or more of the field resources is no longer available. In another embodiment, the system 205 automatically notifies the field resources based on the previous allocation of work assignments from block 222.

The method 200 then proceeds to block 232 where the incident commander confirms that service to all of the customer locations has been turned back on/reconnected. In an embodiment, the system 205 automatically notifies the incident commander when the customer locations are reconnected. Finally, the method 200 proceeds to block 234 where the data regarding the gas outage event is exported for archiving and auditing. An example of a data export 354 is shown in FIG. 3E.

It should be appreciated that embodiments of this disclosure may provide a gas outage management system that includes a system that uses cloud computing. However, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, tablet computers, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various user devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. In essence, cloud computing is an infrastructure made up of a network of interconnected nodes.

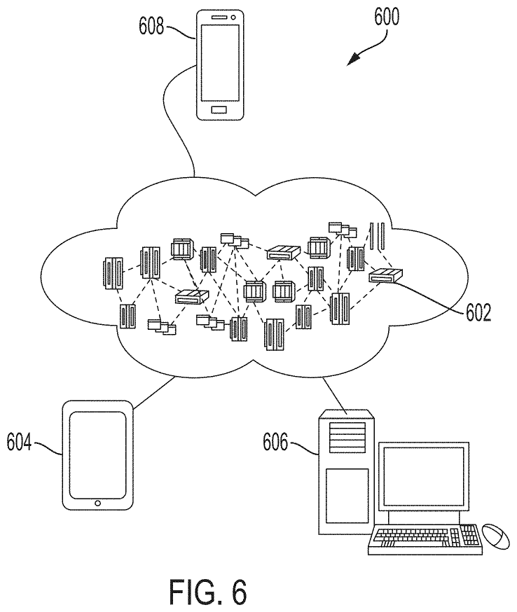

Referring now to FIG. 6, an illustrative cloud computing environment 600 is depicted. As shown, cloud computing environment 600 comprises one or more cloud computing nodes 602 with which local computing devices used by cloud consumers, such as, for example, tablet computer 604, computer or laptop 606, and mobile cellular phone 608 (collectively referred to as computing devices) may communicate. In an embodiment, the processing described herein is performed through the cooperation of computing devices 604, 606, 608. Nodes 602 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 604-608 shown in FIG. 6 are intended to be illustrative only and that computing nodes 602 and cloud computing environment 600 can communicate with any type of computerized device over any type of network and/or network addressable connection (e.g., using a web browser).

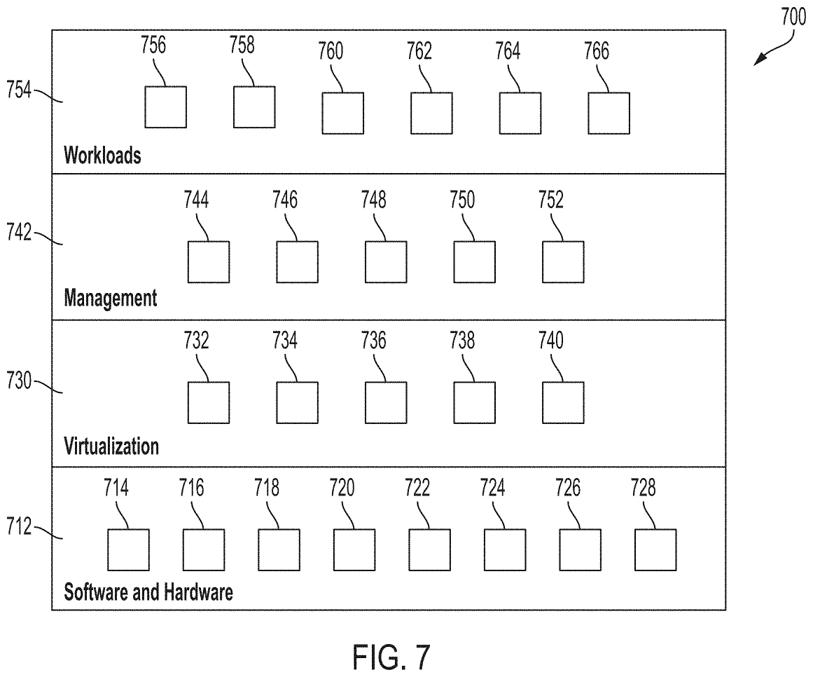

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided: hardware and software layer 712 includes hardware and software components. Examples of hardware components include, but are not limited to: mainframes 714; desktop computer workstations; laptops; tablets; mobile telephones; RISC (Reduced Instruction Set Computer) architecture based servers 716; servers 718; blade servers 720; storage devices 722; and networks and networking components 724.

In some embodiments, software components include network application server software 726, and database software 728; virtualization layer 730 provides an abstraction layer from which the following examples of virtual entities may be provided: virtual servers 732; virtual storage 734; virtual networks 736, including virtual private networks; virtual applications and operating systems 738; and virtual clients 740.

In one example, management layer 742 may provide the functions described below. Resource provisioning 744 provides dynamic procurement of computing resources and other resources that are utilized to perform tasks within the cloud computing environment. Metering and pricing 746 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 748 provides access to the cloud computing environment for consumers and system administrators. Service level management 750 provides cloud computing resource allocation and management such that required service levels are met. Service Level Agreement (SLA) planning and fulfillment 752 provides pre-arrangement for, and procurement of, cloud computing resources for which a future requirement is anticipated in accordance with an SLA.

Workloads layer 754 provides examples of functionality for which the cloud computing environment may be utilized. Examples of workloads and functions which may be provided from this layer include: navigation 756; software development and lifecycle management 758; transaction processing 760; database processing software 762; mapping processing 764; and customer data processing 766.

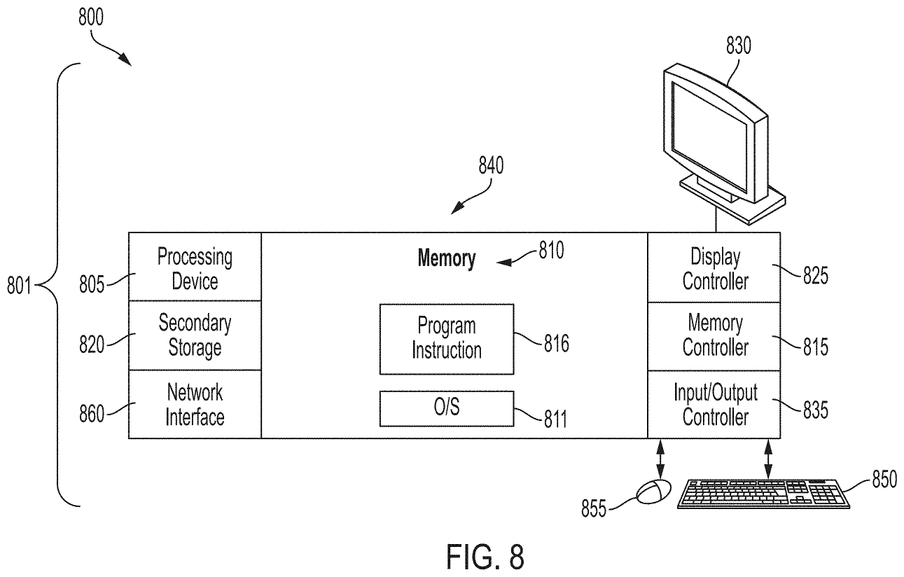

Turning now to FIG. 8, a schematic illustration of a system 800 is depicted upon which aspects of one or more embodiments of operating the system 205 may be implemented. In an embodiment, all or a portion of the system 800 may be incorporated into one or more of the mobile cellular phones, tablet computers, laptop computers, file servers, and processors described herein. In one or more exemplary embodiments, in terms of hardware architecture, as shown in FIG. 8, the computer 801 (also referred to as a “processing system”) includes a processing device 805 and a memory 810 coupled to a memory controller 815 and an input/output controller 835. The input/output controller 835 can be, for example, but not limited to, one or more buses or other wired or wireless connections, as is known in the art. The input/output controller 835 may have additional elements, which are omitted for simplicity, such as controllers, buffers (caches), drivers, repeaters, and receivers, to enable communications. Further, the computer 801 may include address, control, and/or data connections to enable appropriate communications among the aforementioned components.

In one or more exemplary embodiments, a keyboard 850 and mouse 855 or similar devices can be coupled to the input/output controller 835. Alternatively, input may be received via a touch-sensitive or motion sensitive interface (not depicted). The computer 801 can further include a display controller 825 coupled to a display 830.

The processing device 805 is a hardware device for executing software, particularly software stored in secondary storage 820 or memory 810. The processing device 805 can be any custom made or commercially available computer processor, a central processing unit (CPU), an auxiliary processor among several processors associated with the computer 801, a semiconductor-based microprocessor (in the form of a microchip or chip set), a macro-processor, or generally any device for executing instructions.

The memory 810 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory 810 may incorporate electronic, magnetic, optical, and/or other types of storage media. Accordingly, the memory 810 is an example of a tangible computer readable storage medium 840 upon which instructions executable by the processing device 805 may be embodied as a computer program product. The memory 810 can have a distributed architecture, where various components are situated remote from one another, but can be accessed by the processing device 805.

The instructions in memory 810 may include one or more separate programs, each of which comprises an ordered listing of executable instructions for implementing logical functions. In the example of FIG. 8, the instructions in the memory 810 include a suitable operating system (OS) 811 and program instructions 816. The operating system 811 essentially controls the execution of other computer programs and provides scheduling, input-output control, file and data management, memory management, and communication control and related services. When the computer 801 is in operation, the processing device 805 is configured to execute instructions stored within the memory 810, to communicate data to and from the memory 810, and to generally control operations of the computer 801 pursuant to the instructions. Examples of program instructions 816 can include instructions to implement the processing described herein.

The computer 801 of FIG. 8 also includes a network interface 860 that can establish communication channels with one or more other computer systems via one or more network links. The network interface 860 can support wired and/or wireless communication protocols known in the art. For example, when embodied in a user system, the network interface 860 can establish communication channels with an application server.

Embodiments of the present disclosure provide advantages in reducing the response time and improving the communication and efficiency of a natural gas distribution utility in responding to, and managing, a gas outage event.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of restoring gas service to a portion of a natural gas distribution network, the method comprising:
determining a gas outage has occurred;
defining a geographic area where gas service was lost;
identifying customer data associated with the customer locations in the geographic area on the natural gas distribution network and storing the customer data in a database;
assigning, by an incident commander, customer locations to field resources;
notifying the field resources of the customer locations assigned the field resources;
disconnecting, by the field resources, the customer locations from the natural gas distribution network;
updating the database, by the field resources, the customer data to indicate the customer location has been disconnected by the field resources; and
displaying, on a computing device, to the incident commander the customer data indicating that the customer location has been disconnected.

2. The method of claim 1, wherein the step of notifying field resources of the assignment of customer locations is by a mobile computing device.

3. The method of claim 2, wherein the step of updating the database by the field resources of the disconnecting of the customer location is by the mobile computing device.

4. The method of claim 3, wherein the step of notifying the field resources is performed automatically upon assigning of the customer location by the incident commander.

5. The method of claim 2, further comprising scanning a machine readable symbol on a utility meter at the customer location when the customer location is disconnected from the natural gas distribution network.

6. The method of claim 1, further comprising notifying a field crew to initiate repairs of the gas distribution network in response to all of the customer locations being disconnected from the natural gas distribution network.

7. The method of claim 6, further comprising notifying, in a second instance, the field resources that repairs of the natural gas distribution network are completed.

8. The method of claim 7, further comprising reconnecting, by the field resources, the customer locations to the natural gas distribution network.

9. The method of claim 1, wherein the customer data includes a plurality of fields, at least one of the plurality of fields being selected from a group comprising: meter status, facility type, pilot light status, and accessibility.

10. The method of claim 1, further comprising displaying a summary status screen, on a computing device in a central operations center.

11. The method of claim 10, wherein the summary status screen includes a plurality of regions.

12. The method of claim 11, wherein the plurality of regions includes at least one of a map region, a graphical status region, and a numerical status region.

13. A system for restoring natural gas service to a portion of a natural gas distribution network, the system comprising:
a server at a first location, the server having a first processor responsive to executable computer instructions when executed on the first processor for receiving an input and transmitting a data package in response to receiving the input, the input including customer data associated with the portion of the natural gas distribution network, the customer data including a plurality of fields, at least one of the plurality of fields being selected from a group comprising: meter status, facility type, pilot light status, and accessibility;
a database associated with the server; and
a plurality of mobile computing devices at a second location, the second location being different than the first location, the plurality of mobile computing devices being coupled to communicate with the server and the database, each of the first plurality of mobile devices having a first display and a second processor, the second processor being coupled to the first display, the second processor being responsive to executable computer instructions for displaying the customer data, the second processor further being responsive to executable computer instructions for receiving one or more inputs, by a field resource, changing the customer data and transmitting the changed customer data to the database.

14. The system of claim 13, further comprising a computing device at a third location, the third location being different than the first location, the computing device being coupled to communicate with the server and database, the computing device having a third processor and a display, the third processor being responsive to executable computer instructions to display customer data, the third processor further being responsive to executable computer instructions for receiving one or more inputs by an incident commander to assign customer locations to field resources and transmit the assigned customer locations to the database.

15. The method of claim 14, wherein the server is configured to notify the field resources of the assignment of customer locations in response to the assigned customer locations being transmitted to the database.

16. The method of claim 15, wherein the changing of the customer data, by the field resource, is in response to a disconnecting of a customer location from the natural gas distribution network.

17. The method of claim 16, wherein the of notifying the field resources is performed automatically upon transmitting of the assigned customer locations to the database by the computing device.

18. A computer-implemented method for facilitating a restoring of gas service to a portion of a natural gas distribution network, the method comprising:
determining a gas outage has occurred;
defining, at a server, a geographic area where gas service was lost;
identifying, at the server, customer data associated with the customer locations in the geographic area on the natural gas distribution network and storing the customer data in a database, the database being associated with the server;
assigning, by an incident commander computing device, customer locations to field resources;
notifying, via a computer network, a field resource computing device of the customer locations assigned the field resources;
disconnecting, by the field resources, the customer locations from the natural gas distribution network;
in response to an input on the field resource computing device, updating the customer data to indicate the customer location has been disconnected by the field resources;
transmitting the updated customer data to the database; and
displaying, on the incident commander computing device, the customer data indicating that the customer location has been disconnected.

19. The method of claim 18, further comprising scanning a machine readable symbol on a utility meter with the field resource computing device at the customer location when the customer location is disconnected from the natural gas distribution network.

20. The method of claim 18, wherein the customer data includes a plurality of fields, at least one of the plurality of fields being selected from a group comprising: meter status, facility type, pilot light status, and accessibility.
